(19) United States
(12) Patent Application Publication
(10) Pub. No.: US 2013/0290330 A1
(43) Pub. Date: Oct. 31, 2013

(54) METHOD FOR EXTRACTING FINGERPRINT OF PUBLICATION, APPARATUS FOR EXTRACTING FINGERPRINT OF PUBLICATION, SYSTEM FOR IDENTIFYING PUBLICATION USING FINGERPRINT, AND METHOD FOR IDENTIFYING PUBLICATION USING FINGERPRINT

(71) Applicants: Young Suk Yoon, Seoul (KR); Jee Hyun Park, Daejeon (KR); Sang Kwang Lee, Daejeon (KR); Jung Hyun Kim, Daejeon (KR); Young Ho Suh, Daejeon (KR); Yong Seok Seo, Daejeon (KR); Seung Jae Lee, Daejeon (KR); Sung Min Kim, Daejeon (KR); Jung Ho Lee, Wonju (KR); Won Young Yoo, Daejeon (KR)

(72) Inventors: Young Suk Yoon, Seoul (KR); Jee Hyun Park, Daejeon (KR); Sang Kwang Lee, Daejeon (KR); Jung Hyun Kim, Daejeon (KR); Young Ho Suh, Daejeon (KR); Yong Seok Seo, Daejeon (KR); Seung Jae Lee, Daejeon (KR); Sung Min Kim, Daejeon (KR); Jung Ho Lee, Wonju (KR); Won Young Yoo, Daejeon (KR)

(73) Assignee: Electronics & Telecommunications Research Institut, Daejeon (KR)

(21) Appl. No.: 13/879,398

(22) PCT Filed: Oct. 13, 2011
(86) PCT No.: PCT/KR2011/007633

§ 371 Date: Apr. 13, 2013

(30) Foreign Application Priority Data
Oct. 14, 2010 (KR) 10-2010-0100508
Mar. 15, 2011 (KR) 10-2011-0023069

(51) Int. Cl. G06F 17/30

(52) U.S. Cl. CPC G06F 17/30253
USPC 707/736

(57) ABSTRACT

Disclosed are a method and an apparatus for extracting a fingerprint of a publication. And disclosed are a system and a method for identifying a publication using a fingerprint. The system for identifying the publication using the fingerprint includes: a fingerprint extraction unit for extracting fingerprints for collected query publications to identify the copyrights infringement; a fingerprint query unit for querying fingerprints of original publications corresponding from the fingerprint extraction unit; a DBMS for storing the fingerprints extracted from the original publications and additional information from the original publications, and providing a search result candidate group which is composed of fingerprints of at least one of the original publications corresponding to the queries of the fingerprint query unit; and a candidate group verification unit for determining copyright infringement for the query publications by verifying the search result candidate group provided from the DBMS.

### TECHNICAL FIELD

The present invention relates to content identification, and more particularly, to a method and apparatus for extracting a fingerprint of a publication and a system and method for identifying a publication using a fingerprint.

### BACKGROUND ART

Content including text and images or digitized publications are easily duplicated and illegally distributed in various ways such as the Internet and peer-to-peer (P2P) communication. Such illegally-distributed content directly causes economic damage to its creator and also becomes a main factor indirectly ruining a creator's motivation to create.

To prevent illegal distribution of content and protect a copyright, digital rights management (DRM) technology for packaging and encrypting content to cause a content purchase action in an authenticated environment when content is sold or purchased, digital property protection (DPP) technology for preventing content from being stored in a hard disk or printed, watermarking technology for inserting a seller or content copyright holder's information into content not to be shown, etc. have been conventionally used.

FIG. 1 schematically illustrates a general content protection method employing a protection apparatus such as DRM.

Referring to FIG. 1, content providers encrypt and package content using the original content and an encryption key and then provide the content. Only when users legally purchase the content by accessing the corresponding DRM server and performing a purchase authentication process, can they receive a key for a cipher and be licensed to use the content, thereby playing the content.

As illustrated in FIG. 1, conventionally, content providers have protected rights of content creators using a protection method of encryption and packaging such as DRM, and conventional copyright protection methods have been continuously developed into a modified form of the protection method.

In conventional copyright protection methods, copyrights of content are protected by encryption or packaging. However, when a cipher of encrypted content is decrypted or packaged content is unpackaged, content may be illegally distributed. As an example, DRM applied to a specific electronic book reader has been hacked, and electronic publications for the electronic book reader have been illegally distributed without permission.

Recently, with the development of digital cameras, scanners, computers, etc. and the development of image processing technology, duplication of analog or digital publications is being facilitated and becoming exact. For this reason, when a user generates digital files from analog or digitized publications and distributes the digital files for illegal outflow, it is becoming more difficult to determine whether or not a publication has been illegally distributed or whether or not a copyright has been infringed.

Consequently, a method is needed to determine whether or not a copyright of a publication has been infringed and whether or not the publication has been illegally distributed using content identification technology and effectively protect the copyright even when a protection function for content or publications to which the protection function has been applied according to conventional content protection technology has been removed by a malicious user.

### DISCLOSURE

### Technical Problem

The present invention is directed to providing a method of extracting a fingerprint of a publication whereby the publication can be easily identified to determine whether or not a copyright has been infringed and effectively protect the copyright.

The present invention is also directed to providing a fingerprint extraction apparatus that performs the method of extracting a fingerprint of a publication.

The present invention is also directed to providing a system for identifying a publication using a fingerprint that can easily identify a publication and effectively protect a copyright.

The present invention is also directed to providing an operation method of the system for identifying a publication using a fingerprint.

### Technical Solution

One aspect of the present invention provides a method of extracting a fingerprint, including: extracting text from an input electronic document in the form of text; and extracting a text fingerprint from the extracted text.

Extracting the text from the input electronic document in the form of text may include preprocessing the input electronic document in the form of text, and then extracting the text from the input electronic document in the form of text.

Preprocessing the input electronic document in the form of text may include correction of a typing error or restoration of a character.

Another aspect of the present invention provides a method of extracting a fingerprint, including: receiving an electronic document in the form of an image; converting the input electronic document in the form of an image into an electronic document in the form of text when the input electronic document in the form of an image is based on text; extracting text from the converted electronic document in the form of text; and extracting a text fingerprint from the extracted text.

Receiving the electronic document in the form of an image may include preprocessing the electronic document in the form of an image after the electronic document in the form of an image is received.

Preprocessing the electronic document in the form of an image may include performing at least one of removal of noise included in the electronic document in the form of an image, page separation, image rotation, and adjustment of the inclination of an image.

The method may further include: when the input electronic document in the form of an image is based on an image, preprocessing the input electronic document in the form of an image; and extracting an image fingerprint from the preprocessed electronic document in the form of an image.

Still another aspect of the present invention provides an apparatus for extracting a fingerprint, including: an image-text converter configured to convert an input electronic document in the form of an image into an electronic document in the form of text; a text extractor configured to extract text from the electronic document in the form of text; and a fingerprint extractor configured to extract a text fingerprint from the extracted text.

The apparatus may further include an image preprocessor configured to perform at least one of removal of noise included in the input electronic document in the form of an image, page separation, image rotation, and adjustment of the inclination of an image.

The fingerprint extractor may extract an image fingerprint from a preprocessed image provided by the image preprocessor.

The fingerprint extractor apparatus may further include a text preprocessor configured to preprocess the electronic document in the form of text provided by the image-text converter or an input electronic document in the form of text, and then provide the preprocessed electronic document in the form of text to the text extractor.

Yet another aspect of the present invention provides a system for identifying a publication using a fingerprint, including: a fingerprint extraction apparatus configured to extract a fingerprint of an original publication; a publication information construction apparatus configured to store the fingerprint of the original publication provided by the fingerprint extraction apparatus and additional information about the original publication in connection with each other; and a database management system (DBMS) configured to store the fingerprint extracted from the original publication and the additional information about the original publication.

The fingerprint extraction apparatus may extract text from an electronic document in the form of text and then a text fingerprint from the extracted text when the original publication or a query publication is the electronic document in the form of text, and convert an electronic document in the form of an image into an electronic document in the form of text, extract text from the converted electronic document in the form of text, and then extract a text fingerprint from the extracted text when the original publication or the query publication is the electronic document in the form of an image.

The fingerprint extraction apparatus may preprocess the electronic document in the form of an image and then extract an image fingerprint from the preprocessed electronic document in the form of an image when the original publication or the query publication is the electronic document in the form of an image.

The additional information about the original publication may include at least one piece of information among a creator, a publishing company, a title, a summary, a publication date, an international standard book number (ISBN), an address, a phone number, and a fax number of the original publication.

Yet another aspect of the present invention provides a system for identifying a publication using a fingerprint, including: a fingerprint extraction apparatus configured to extract a fingerprint of a query publication collected for identification; a fingerprint query apparatus configured to query a fingerprint of an original publication corresponding to the fingerprint of the query publication provided by the fingerprint extraction apparatus; a DBMS configured to store the fingerprint extracted from the original publication and additional information about the original publication, and provide a search result candidate group consisting of at least one fingerprint of the original publication in response to the query of the fingerprint query apparatus; and a candidate group verification apparatus configured to verify the search result candidate group provided by the DBMS and determine whether or not a copyright of the query publication has been infringed.

The candidate group verification apparatus may compare the fingerprint of the search result candidate group with the fingerprint of the query publication, and identify the query publication on the basis of the comparison result

The candidate group verification apparatus may obtain additional information about the query publication from the DBMS and provide the obtained additional information when the query publication is determined to be in the DBMS.

Yet another aspect of the present invention provides a method of identifying a publication using a fingerprint, including: extracting a fingerprint of a collected query publication; searching a DBMS for a fingerprint of an original publication corresponding to the fingerprint extracted from the collected query publication; and determining whether a copyright of the collected query publication has been infringed on the basis of at least one search result.

Identifying the collected query publication on the basis of the at least one search result may include identifying the query publication on the basis of a comparison result obtained by comparing the at least one search result with the fingerprint of the query publication.

The method may further include obtaining additional information about the query publication from the DBMS when it is determined as a result of identifying the collected query publication that the query publication is identical to the original publication.

### Advantageous Effects

Using the above-described method and apparatus for extracting a fingerprint of a publication and the above-described system and method for identifying a publication using a fingerprint, a fingerprint of an original publication can be extracted and managed in connection with metadata information about the publication, and a fingerprint of a query publication can be extracted to identify an unknown publication. Also, using information about an identified publication, it is determined whether or not the publication has been illegally distributed or whether or not a copyright of the publication has been infringed.

Thus, even when a publication is directly typed, scanned or captured by a camera and converted into a digitized publication, or even when various protection apparatuses such as digital rights management (DRM) are removed or a system administrator converts a publication into the same digital publication as the publication using his/her access authority and illegally distributes the digital publication, the digitized or digital publication can be easily identified, and thus it is possible to reduce illegal circulation or distribution and prevent copyright infringement.

Also, a system for identifying a publication using a fingerprint according to an exemplary embodiment of the present invention can be used to search for information about an original publication by inputting partial information about a publication (e.g., several pages of the publication).

### DESCRIPTION OF DRAWINGS

FIG. 1 schematically illustrates a general content protection method employing a protection apparatus such as digital rights management (DRM).

FIG. 2 illustrates examples of technology for protecting copyrights of publications.

FIG. 3 is a flowchart illustrating a method of extracting a text fingerprint from an electronic document form.

FIG. 4 is a flowchart illustrating a method of extracting a text fingerprint from a publication in the form of an image.

FIG. 5 is a flowchart illustrating a method of extracting an image fingerprint from a publication in the form of an image.

FIG. 6 is a flowchart illustrating a method of extracting a fingerprint of a publication according to an exemplary embodiment of the present invention.

FIG. 7 is a block diagram of an apparatus for extracting a fingerprint of a publication according to an exemplary embodiment of the present invention.

FIG. 8 is a block diagram of a system for identifying a publication according to an exemplary embodiment of the present invention.

FIG. 9 is a block diagram of a system for identifying a publication according to another exemplary embodiment of the present invention.

FIG. 10 is a flowchart illustrating a publication identification method of a publication identification system according to an exemplary embodiment of the present invention.

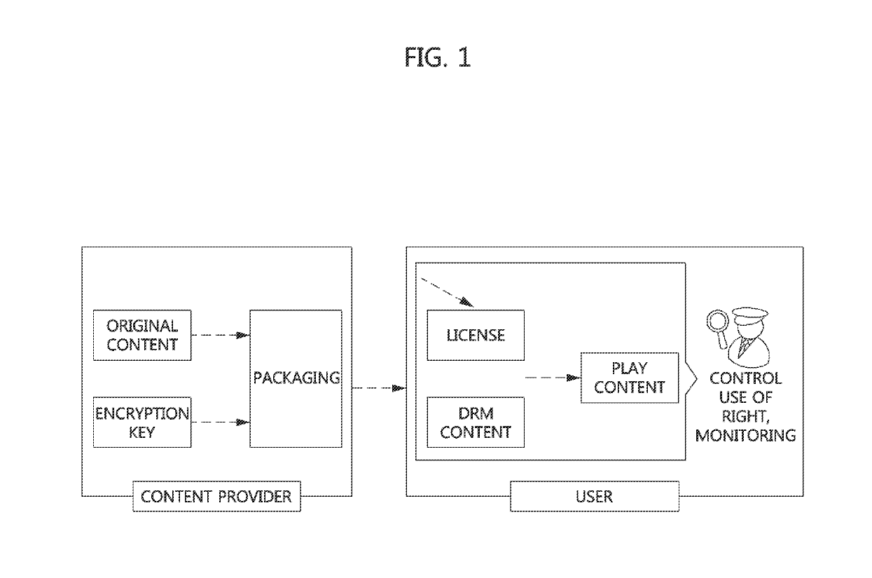

### MODES OF THE INVENTION

While the invention is susceptible to various modifications and alternative forms, specific embodiments thereof are shown by way of example in the drawings and will herein be described in detail.

However, it should be understood that there is no intent to limit the invention to the particular forms disclosed, but on the contrary, the invention is to cover all modifications, equivalents, and alternatives falling within the spirit and scope of the invention

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined here.

Hereinafter, exemplary embodiments of the present invention will be described in detail. To facilitate understanding of the present invention, like numbers refer to like elements throughout the description of the drawings, and description of the same element will not be reiterated.

Digitization methods for illegally distributing a publication can be classified into four types.

First, original content may be leaked when a publication creator loses a storage medium in which a publication is stored or neglects to manage the storage medium, when a publication file provided to a publishing company in the form of a digital file is leaked, when digital rights management (DRM) is cancelled and a file is leaked, or so on.

Second, a user may manually type a publication printed in the form of book, etc. to digitize the publication. In this case, the printed publication is converted into the form of an electronic document, and a high-quality pirated edition of the publication may be produced in large quantities by mass printing, etc.

Third, a user may digitize a publication printed as a novel, magazine, comic book, etc. by scanning the publication. Here, the user may break up the printed publication and use an automatic input device of a scanner, use a device for automatically turning the publication, or store the printed publication in the form of an image by scanning the publication while manually turning the publication, thereby digitizing the publication.

Fourth, a user may digitize a printed publication by capturing the publication using a camera. In this case, a digitized file may be stored in the form of an image, and quality may vary according to skill of the capturing user

Consequently, copyright protection technology is required to cope with the four types of digitization methods for illegally distributing a publication as above-described.

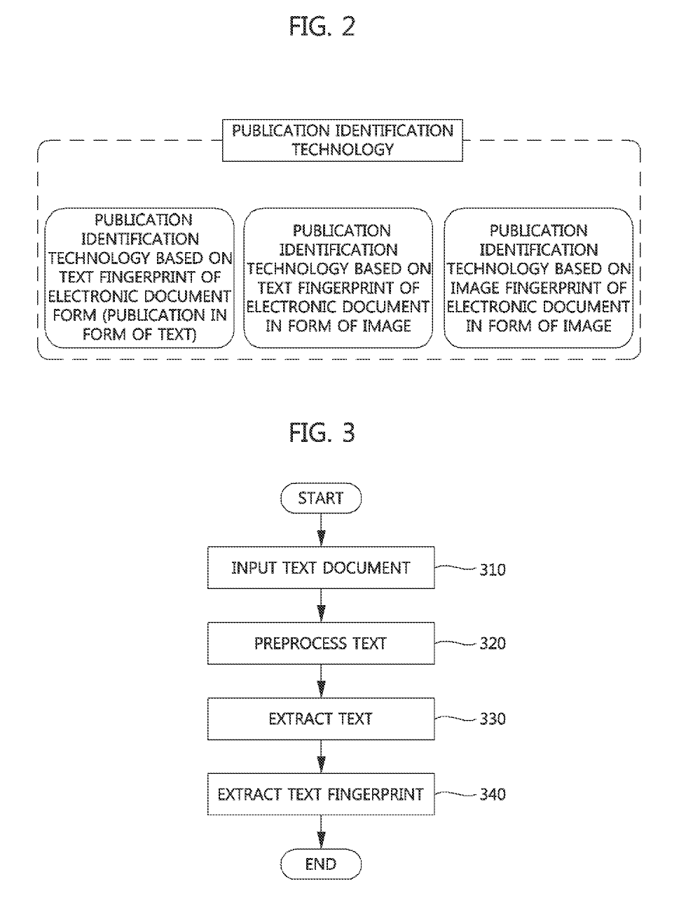

FIG. 2 illustrates examples of technology for protecting copyrights of publications.

As illustrated in FIG. 2, technology for protecting copyrights of publications can be briefly classified into three types.

Publications provide information to readers by means of text and images. Text is a main means for publications such as novels to transfer information, and images are main means for publications such as magazines and comic books to transfer information.

Among the above-described digitization methods for illegally distributing a publication, the first and second methods digitize a publication in the form of an electronic document, and thus require a technique for identifying a publication on the basis of a text fingerprint of an electronic document form.

Also, among the above-described digitization methods for illegally distributing a publication, the third and fourth methods digitize a publication in the form of an image. When the publication digitized in the form of an image is a text-based publication such as a novel, a technique is required to identify a publication on the basis of a text fingerprint of an image file form, and when the publication digitized in the form of an image is an image-based publication such as a magazine or comic book, a technique is required to identify a publication on the basis of an image fingerprint of an image file form. Here, a fingerprint denotes unique feature information about the corresponding content or publication, and may be referred to as a feature point or deoxyribonucleic acid (DNA).

FIG. 3 is a flowchart illustrating a method of extracting a text fingerprint from an electronic document form.

In exemplary embodiments of the present invention below, an electronic document form denotes a document file (e.g., TXT, Hangul file, Word file, portable document format (PDF) file stored in the form of text) written in an information processing apparatus including a computer, etc. using various document writing programs and stored in the form of text.

First, when text documents are input to a fingerprint extraction apparatus (step 310), the fingerprint extraction apparatus performs text preprocessing to facilitate extraction of text from the input text documents (step 320). Here, the input text documents may be electronic documents written using various document writing programs as mentioned above. Also, the text preprocessing process may include a typing error correction process, a process of restoring a character that has an abnormal form due to an error, or so on. The text preprocessing process need not necessarily be performed, and may be selectively performed only in case of need.

Subsequently, the fingerprint extraction apparatus extracts only text, which is an information transfer means of publications, from the text documents that have undergone text preprocessing to extract a fingerprint (step 330).

The fingerprint extraction apparatus extracts a fingerprint from the text extracted in step 330, thereby extracting a fingerprint of a publication in the form of a text-based electronic document (step 340).

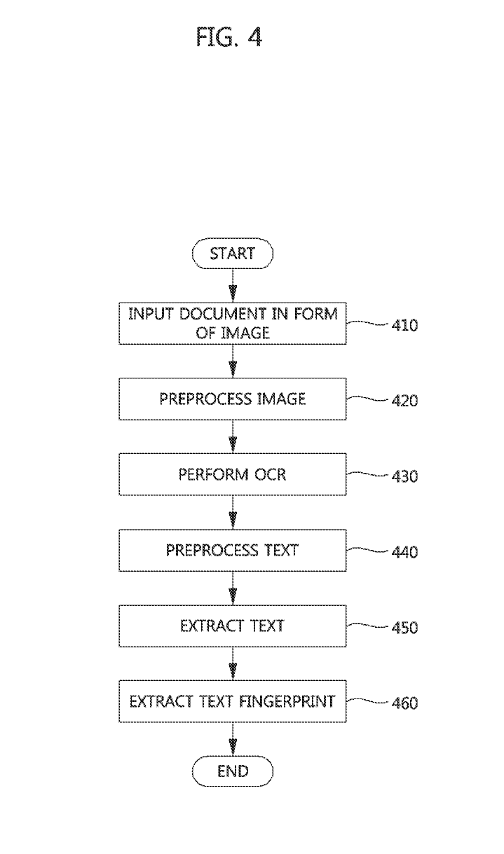

FIG. 4 is a flowchart illustrating a method of extracting a text fingerprint from a publication in the form of an image.

First, when a document in the form of an image file scanned by a scanner or captured by a camera is input to a fingerprint extraction apparatus (step 410), the fingerprint extraction apparatus performs image preprocessing to improve optical character recognition (OCR) performance for the input document in the form of an image file (step 420). Here, the form of an image file denotes an image file in a form that can be displayed by a commercial image viewer, and image preprocessing is a process of processing factors that may deteriorate text recognition performance when OCR is applied to a document in the form of an image and may include processes such as noise removal, page separation, rotation, and inclination adjustment.

Subsequently, the fingerprint extraction apparatus performs OCR on the preprocessed document in the form of an image file, thereby converting the document in the form of an image file into an electronic document in the form of text (step 430). Here, an abnormal character (or noise) misrecognized due to a limitation of OCR performance may be included in the electronic document converted into text through OCR, and thus a process is required to remove the abnormal character (or noise).

Thus, the fingerprint extraction apparatus performs a preprocess for removing an abnormal character or noise as mentioned above from the electronic document in the form of text converted in step 430 (step 440).

Subsequently, the fingerprint extraction apparatus extracts text from the preprocessed electronic document in the form of text (step 450), and extracts a text fingerprint from the extracted text (step 460).

The text preprocessing process, the text extraction process, and the text fingerprint extraction process of steps 440 to 460 may be performed according to a recognition algorithm and performance of OCR performed in step 430.

In other words, steps 320 to 340 illustrated in FIG. 3 perform the same function as steps 440 to 460 illustrated in FIG. 4, respectively. However, while a fingerprint is extracted from an electronic document in the form of text having relatively little noise in the fingerprint extraction process illustrated in FIG. 3, a fingerprint is extracted after an input document in the form of an image file undergoes OCR and conversion into an electronic document in the form of text in the fingerprint extraction process illustrated in FIG. 4. Thus, a probability that noise will be included in the converted electronic document increases due to OCR performance

Consequently, a fingerprint extraction apparatus performing the fingerprint extraction method illustrated in FIG. 4 may be more robust to noise than a fingerprint extraction apparatus performing the fingerprint extraction method illustrated in FIG. 3. When a fingerprint extraction apparatus robust to noise is used to perform the fingerprint extraction method illustrated in FIG. 4, the fingerprint extraction process illustrated in FIG. 3 may be included in FIG. 4.

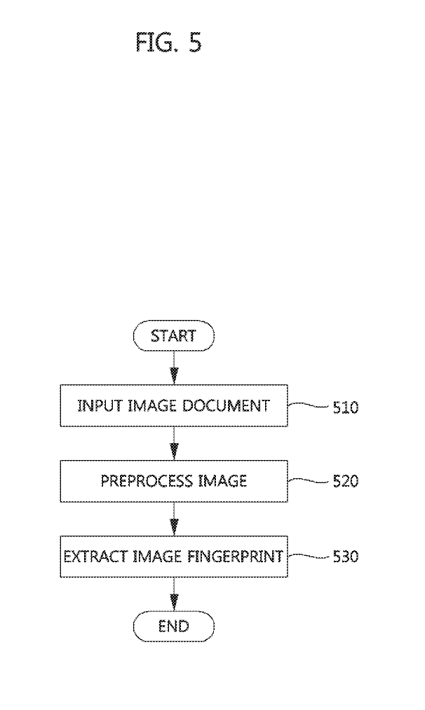

FIG. 5 is a flowchart illustrating a method of extracting an image fingerprint from a publication in the form of an image.

As mentioned above, images are main means for publications such as magazines and comic books to transfer information. Thus, from a publication in which images are used as means for transferring information as mentioned above, an image fingerprint is extracted for copyright protection.

Referring to FIG. 5, when a document in the form of an image scanned by a scanner or captured by a camera is input to a fingerprint extraction apparatus (step 510), the fingerprint extraction apparatus performs a preprocess for effectively extracting a fingerprint from the input document in the form of an image (step 520). Here, the preprocess includes a process of removing factors that may disturb extraction of an image fingerprint, for example, noise removal, page separation, rotation, and inclination adjustment.

Subsequently, the fingerprint extraction apparatus extracts an image fingerprint from the preprocessed image (step 530).

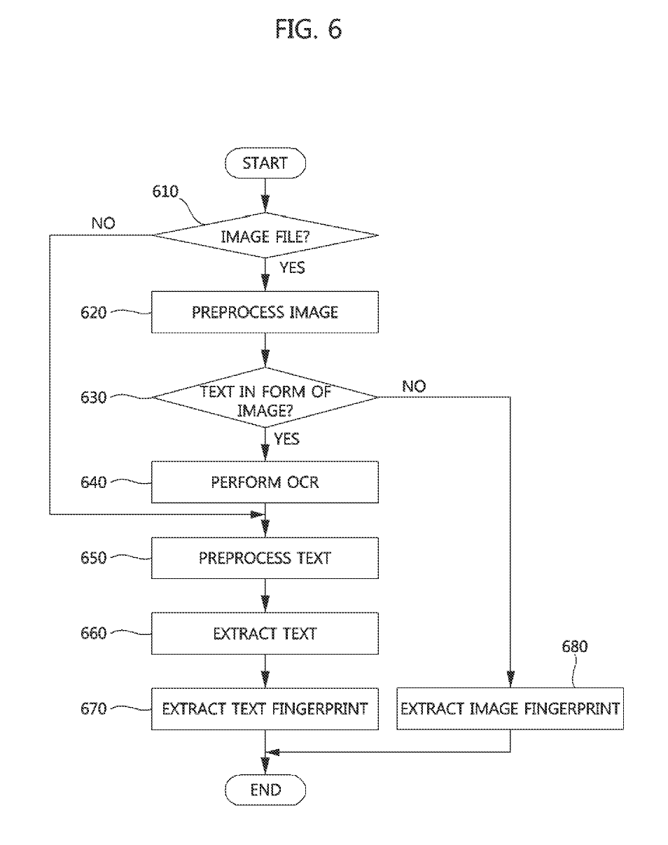

FIG. 6 is a flowchart illustrating a method of extracting a fingerprint of a publication according to an exemplary embodiment of the present invention in which descriptions of FIGS. 2 to 5 are put together.

Referring to FIG. 6, when a digitized publication for fingerprint extraction is input to a fingerprint extraction apparatus, the fingerprint extraction apparatus determines whether the input digital publication is an image file or a text file (step 610). When the input digital publication is an image file, the fingerprint extraction apparatus preprocesses the image (step 620). Here, image preprocessing is a process of removing factors that may deteriorate text recognition performance or factors that may disturb image fingerprint extraction when OCR is applied to a document in the form of an image, and may include processes such as noise removal, page separation, rotation, and inclination adjustment.

Subsequently, the fingerprint extraction apparatus determines whether the preprocessed image is text in the form of an image (step 630). When the preprocessed image is determined as text in the form of an image, the fingerprint extraction apparatus performs OCR, thereby converting the text in the form of an image into an electronic document in the form of text (step 640). Here, an abnormal character (or noise) misrecognized in the OCR process due to a limitation of recognition performance may be included in the electronic document converted into text through OCR, and thus a process is required to remove the abnormal character (or noise).

The fingerprint extraction apparatus performs a text preprocess for removing an abnormal character or noise as mentioned above from the electronic document in the form of text converted in step 640 (step 650).

Subsequently, the fingerprint extraction apparatus extracts text from the preprocessed electronic document in the form of text (step 660), and extracts a text fingerprint from the extracted text (step 670).

Meanwhile, when it is determined in step 610 that the input digital publication is a text document, the fingerprint extraction apparatus proceeds to step 650 and performs steps 650 to 670 in sequence without performing steps 620 to 640.

Also, when it is determined in step 630 that the preprocessed image is an image, such as a magazine or comic book, rather than text in the form of an image, the fingerprint extraction apparatus proceeds to step 680 and extracts an image fingerprint from the preprocessed image without performing steps 640 to 670.

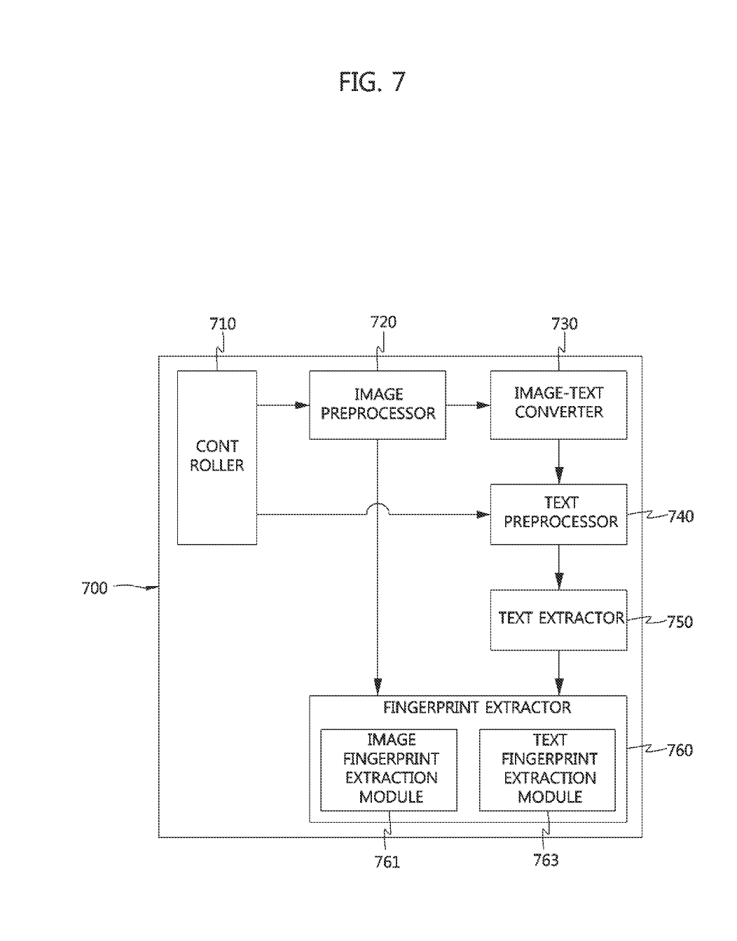

FIG. 7 is a block diagram of an apparatus for extracting a fingerprint of a publication according to an exemplary embodiment of the present invention.

Referring to FIG. 7, an apparatus 700 for extracting a fingerprint according to an exemplary embodiment of the present invention may include a controller 710, an image preprocessor 720, an image-text converter 730, a text preprocessor 740, a text extractor 750, and a fingerprint extractor 760.

The controller 710 determines a type of a digitized and input publication, and provides the input digital publication to the image preprocessor 720 or the text preprocessor 740 according to the determination result.

For example, the controller 710 provides an input publication to the image preprocessor 720 when the input publication is an electronic document in the form of an image scanned by a scanner or captured by a camera, and provides the input publication to the text preprocessor 740 when the input publication is an electronic document in the form of text.

In addition to the above-described function, the controller 710 can control operation of the other components constituting the apparatus 700 for extracting a fingerprint.

The image preprocessor 720 performs a preprocess such as noise removal, page separation, rotation, and inclination adjustment to improve OCR performance for an electronic document in the form of an image provided by the controller 710, and then determines a type of the preprocessed image. The image preprocessor 720 provides the electronic document to the image-text converter 730 when the preprocessed image is the electronic document in the form of an image consisting of text, and to the fingerprint extractor 760 when the preprocessed image consists of images as in a magazine or comic book.

The image-text converter 730 may be configured for OCR. After converting the preprocessed image provided by the image preprocessor 720 into an electronic document in the form of text, the image-text converter 730 provides the converted electronic document in the form of text to the text extractor 750.

The text preprocessor 740 performs a preprocess for removing an abnormal character or noise from the electronic document in the form of text provided by the text preprocessor 740 or the controller 710, and then provides the preprocessed electronic document in the form of text to the text extractor 750.

The text extractor 750 receives the preprocessed electronic document in the form of text from the text preprocessor 740, extracts text that is an information transfer means of publications, and then provides the extracted text to the fingerprint extractor 760.

The fingerprint extractor 760 extracts an image fingerprint from the preprocessed image provided by the image preprocessor 720, or a text fingerprint from the text provided by the text extractor 750. At this time, the fingerprint extractor 720 can extract a fingerprint from the image or text using a well-known fingerprint extraction technique.

Specifically, the fingerprint extractor 760 may include an image fingerprint extraction module 761 and a text fingerprint extraction module 763. The image fingerprint extraction module 761 extracts an image fingerprint from the preprocessed image provided by the image-preprocessor 720, and the text fingerprint extraction module 763 extracts a fingerprint from the text provided by the text extractor 750.

The method and apparatus for extracting a fingerprint of a publication according to an exemplary embodiment of the present invention may be used to extract a fingerprint of an original publication, fingerprints of illegally-distributed publications searched or collected via the Internet, or a fingerprint of any publication whose information is desired. Also, the method and apparatus for extracting a fingerprint of a publication according to an exemplary embodiment of the present invention may be used to extract a fingerprint of a query publication.

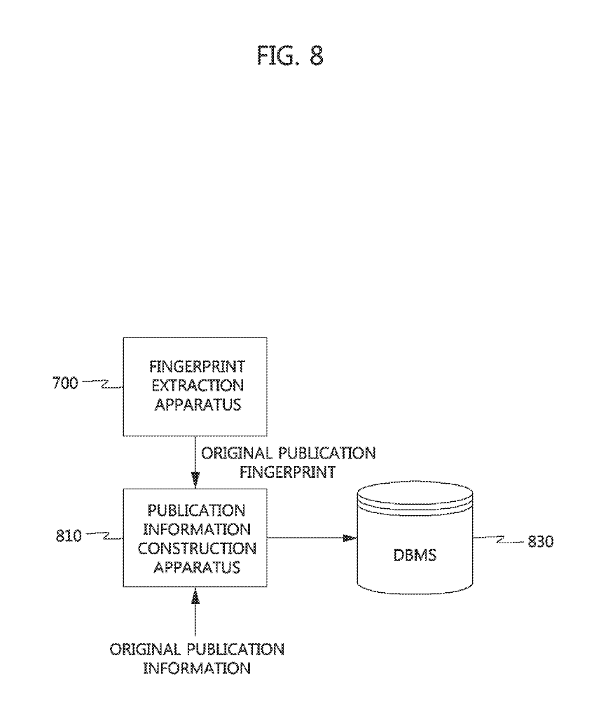

FIG. 8 is a block diagram of a system for identifying a publication according to an exemplary embodiment of the present invention. FIG. 8 shows an example of a system for constructing a database using a fingerprint of a publication when the original publication is provided for copyright protection by a publication copyright holder or a publication provider.

Referring to FIG. 8, the system for identifying a publication according to an exemplary embodiment of the present invention may include a fingerprint extraction apparatus 700, a publication information construction apparatus 810, and a database management system (DBMS) 830.

The fingerprint extraction apparatus 700 has the same constitution as shown in FIG. 7. After extracting a fingerprint of an original publication using the method of extracting a fingerprint illustrated in FIG. 6, the fingerprint extraction apparatus 700 provides the extracted fingerprint of the original publication to the publication information construction apparatus 810.

After receiving the fingerprint of the original publication from the fingerprint extraction apparatus 700 and information about the original publication from a publication copyright holder or a publication provider, the publication information construction apparatus 810 provides the fingerprint of the original publication and the information about the original publication to the DBMS 830 in connection with each other and manages the fingerprint of the original publication and the information about the original publication. Here, the information about the original publication may include various pieces of information relating to the original publication, such as a creator, a publishing company, a title, a summary, a publication date, an international standard book number (ISBN), an address, a phone number, and a fax number of the original publication.

Also, the publication information construction apparatus 810 may store the original publication in the DBMS 830 to manage a publication, and may encrypt all or a part of a publication and store the encrypted publication in the DBMS 830 when security is required.

The DBMS 830 stores the fingerprint of the original publication provided by the publication information construction apparatus 810 and the publication information connected with the fingerprint. Also, the DBMS 830 may store the original publication according to a provision of the publication information construction apparatus 810.

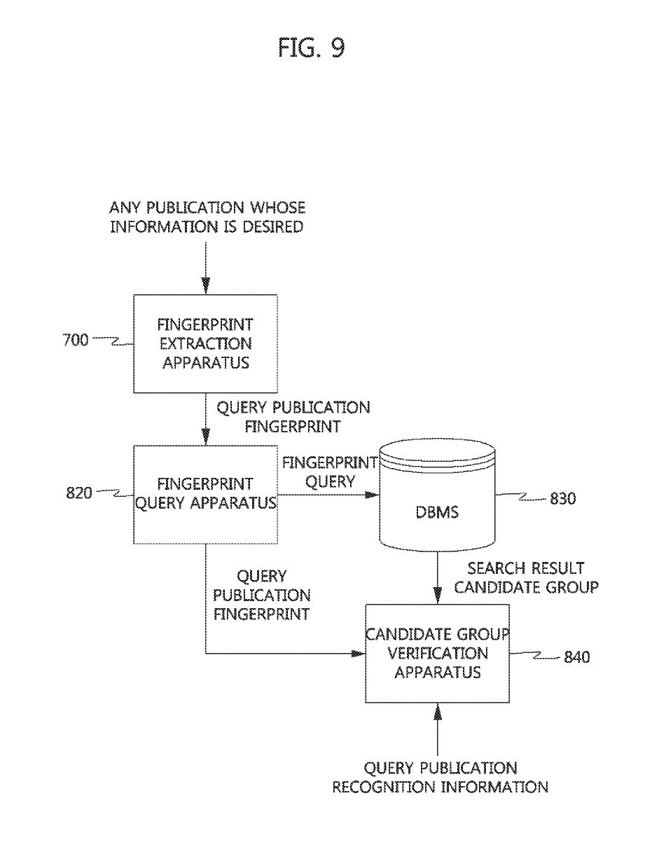

FIG. 9 is a block diagram of a system for identifying a publication according to another exemplary embodiment of the present invention.

A file of a digital publication or a digitized publication file can be easily distributed via the Internet, and so on. For example, publication files can be distributed through a variety of Internet routes, such as peer-to-peer (P2P) communication, a torrent, a web-based hard disk, a web-based club, and a blog. Also, a digital publication or a digitized publication can be easily duplicated and moved due to characteristics of digital files, and thus can also be distributed through portable storages, portable terminals, and so on.

The system for identifying a publication according to the other exemplary embodiment of the present invention shown in FIG. 9 is used to identify a publication illegally distributed through a variety of routes as mentioned above, a copyright-infringing publication, or a publication desired to be known. Referring to FIG. 9, the system for identifying a publication according to the exemplary embodiment of the present invention may include a fingerprint extraction apparatus 700, a fingerprint query apparatus 820, a DBMS 830, and a candidate group verification apparatus 840.

The fingerprint extraction apparatus 700 has the same constitution as shown in FIG. 7, and executes the method of extracting a fingerprint illustrated in FIG. 6. After extracting fingerprints of query publications searched and collected through a variety of routes, the fingerprint extraction apparatus 700 provides the extracted fingerprints to the fingerprint query apparatus 820 to determine whether or not a publication has been illegally distributed or a copyright of a publication has been infringed.

The fingerprint query apparatus 820 queries the DBMS 830 about the fingerprints of the query publications provided by the fingerprint extraction apparatus 700. Also, the fingerprint query apparatus 820 provides the fingerprints of the query publications provided by the fingerprint extraction apparatus 700 to the candidate group verification apparatus 840.

The DBMS 830 receives a fingerprint of a query publication from the fingerprint query apparatus 820, searches a database for a fingerprint corresponding to the fingerprint, and then provides at least one search result candidate group to the candidate group verification apparatus 840. Here, the search result candidate group may include at least one fingerprint of an original publication similar to that of the query publication and information about the original publication.

The candidate group verification apparatus 840 verifies the search result candidate group provided by the DBMS 830, thereby determining whether or not the query publication has been illegally distributed or a copyright of the query publication has been infringed.

For example, by comparing fingerprints of the search result candidate group provided by the DBMS 830 and the query publication provided by the fingerprint query apparatus 820, the candidate group verification apparatus 840 may determine whether or not the query publication has been illegally distributed or whether or not a copyright of the query publication has been infringed. Also, the candidate group verification apparatus 840 may obtain information about a publication that has been illegally distributed or whose copyright has been infringed from the DBMS 830 and provide the obtained information to the corresponding agency or administrator.

In the systems for identifying a publication shown in FIGS. 8 and 9, a fingerprint extraction apparatus requires much processing time to extract a fingerprint of a publication, and thus may be configured in a distributed fashion by cloud computing to reduce a load of the systems. Also, to improve the systems for identifying a publication and reduce an overall load, a technique for preventing a process from searching again for a file that has been searched already by separately processing the file using a hash technique, etc. may be used.

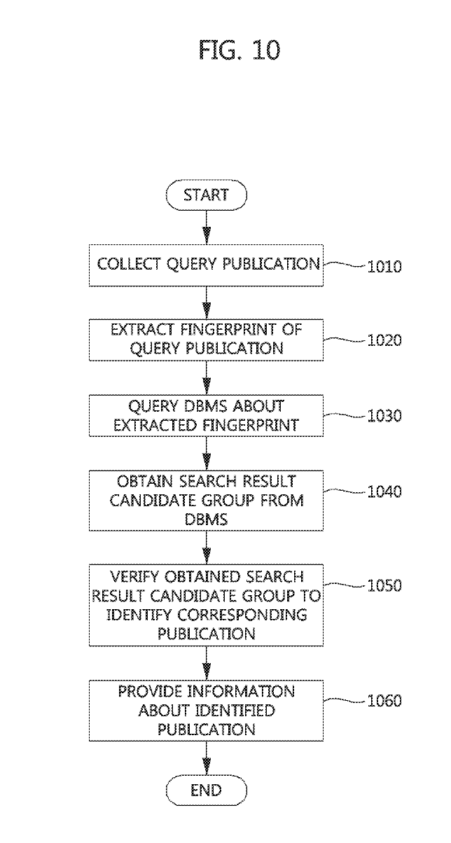

FIG. 10 is a flowchart illustrating a publication identification method of a publication identification system according to an exemplary embodiment of the present invention.

Referring to FIG. 10, first, the publication identification system searches for and collects a publication suspected to have been illegally distributed or to be infringing a copyright as a query publication (step 1010), and extracts a fingerprint of the collected query publication (step 1020).

Subsequently, the publication identification system queries a DBMS about a publication corresponding to the extracted fingerprint (step 1030), and obtains the corresponding search result candidate group from the DBMS (step 1040). Here, the search result candidate group obtained from the DBMS may include a fingerprint of at least one publication corresponding to the fingerprint of the query publication.

Subsequently, the publication identification system verifies the obtained search result candidate group, thereby identifying the corresponding publication determined to have been illegally distributed (or circulated) or to have an infringed copyright (step 1050). At this time, the publication identification system may identify the corresponding publication on the basis of a comparison result between the fingerprint extracted in step 1020 and the fingerprint provided by the DBMS.

Subsequently, the publication identification system obtains information about the publication that has been illegally distributed or whose copyright has been infringed, and provides the obtained information (step 1060).

As described above, the system for identifying a publication according to an exemplary embodiment of the present invention extracts a fingerprint of a publication for which copyright protection has been requested in advance using the original publication, and manages the fingerprint in connection with metadata information about the publication. In this way, a system for publication identification and copyright protection is constructed, and a publication that has been illegally distributed or whose copyright has been infringed is identified using a fingerprint of the publication, so that a copyright can be protected.

Also, exemplary embodiments of the present invention prevent illegal distribution using fingerprints when encryption and packaging are removed, and enable a proper protective action when the corresponding publications are distributed without permission.

Further, a system for identifying a publication using a fingerprint according to an exemplary embodiment of the present invention can also be used to search for information about an original publication by inputting partial information about a publication (e.g., several pages of the publication). This is enabled when the system for identifying a publication using a fingerprint according to an exemplary embodiment of the present invention uses a fingerprint based on a feature point denoting unique information about content.

While the invention has been shown and described with reference to certain exemplary embodiments thereof, it will be understood by those skilled in the art that various changes in form and details may be made therein without departing from the spirit and scope of the invention as defined by the appended claims.

1. A method of extracting a fingerprint of a publication, comprising:
extracting text from an input electronic document in the form of text; and
extracting a text fingerprint from the extracted text.

2. The method of claim 1, wherein extracting the text from the input electronic document in the form of text includes preprocessing the input electronic document in the form of text, and then extracting the text from the input electronic document in the form of text.

3. The method of claim 2, wherein preprocessing the input electronic document in the form of text includes correction of a typing error or restoration of a character.

4. A method of extracting a fingerprint of a publication, comprising:
receiving an electronic document in the form of an image;
converting the input electronic document in the form of an image into an electronic document in the form of text when the input electronic document in the form of an image is based on text;
extracting the text from the converted electronic document in the form of text; and
extracting a text fingerprint from the extracted text.

5. The method of claim 4, wherein receiving the electronic document in the form of an image includes preprocessing the electronic document in the form of an image after the electronic document in the form of an image is received.

6. The method of claim 5, wherein preprocessing the electronic document in the form of an image includes performing at least one of removal of noise included in the electronic document in the form of an image, page separation, image rotation, and adjustment of an inclination of an image.

7. The method of claim 4, further comprising:
when the input electronic document in the form of an image is based on an image, preprocessing the input electronic document in the form of an image; and
extracting an image fingerprint from the preprocessed electronic document in the form of an image.

8. The method of claim 4, wherein extracting the text from the converted electronic document in the form of text includes preprocessing the converted electronic document in the form of text, and then extracting the text from the converted electronic document in the form of text.

9. An apparatus for extracting a fingerprint of a publication, comprising:
an image-text converter configured to convert an input electronic document in the form of an image into an electronic document in the form of text;
a text extractor configured to extract text from the electronic document in the form of text; and
a fingerprint extractor configured to extract a text fingerprint from the extracted text.

10. The apparatus of claim 9, further comprising an image preprocessor configured to perform at least one of removal of noise included in the input electronic document in the form of an image, page separation, image rotation, and adjustment of an inclination of an image.

11. The apparatus of claim 10, wherein the fingerprint extractor extracts an image fingerprint from a preprocessed image provided by the image preprocessor.

12. The apparatus of claim 9, further comprising a text preprocessor configured to preprocess the electronic document in the form of text provided by the image-text converter or an input electronic document in the form of text, and then provide the preprocessed electronic document in the form of text to the text extractor.

13. A system for identifying a publication using a fingerprint, comprising:
a fingerprint extraction apparatus configured to extract a fingerprint of an original publication;
a publication information construction apparatus configured to store the fingerprint of the original publication provided by the fingerprint extraction apparatus and additional information about the original publication in connection with each other; and
a database management system (DBMS) configured to store the fingerprint extracted from the original publication and the additional information about the original publication.

14. The system of claim 13, wherein the fingerprint extraction apparatus extracts text from an electronic document in the form of text and then a text fingerprint from the extracted text when the original publication or a query publication is the electronic document in the form of text, and
converts an electronic document in the form of an image into an electronic document in the form of text, extracts text from the converted electronic document in the form of text, and then extracts a text fingerprint from the extracted text when the original publication or the query publication is the electronic document in the form of an image.

15. The system of claim 14, wherein, when the original publication or the query publication is the electronic document in the form of an image, the fingerprint extraction apparatus preprocesses the electronic document in the form of an image and then extracts an image fingerprint from the preprocessed electronic document in the form of an image.

16. The system of claim 13, wherein the additional information about the original publication includes at least one piece of information among a creator, a publishing company, a title, a summary, a publication date, an international standard book number (ISBN), an address, a phone number, and a fax number of the original publication.

17. A system for identifying a publication using a fingerprint, comprising:
a fingerprint extraction apparatus configured to extract a fingerprint of a query publication collected to determine copyright infringement;
a fingerprint query apparatus configured to query a fingerprint of an original publication corresponding to the fingerprint of the query publication provided by the fingerprint extraction apparatus;
a database management system (DBMS) configured to store the fingerprint extracted from the original publication and additional information about the original publication, and provide a search result candidate group consisting of at least one fingerprint of the original publication in response to the query of the fingerprint query apparatus; and
a candidate group verification apparatus configured to verify the search result candidate group provided by the DBMS and determine whether or not a copyright of the query publication has been infringed.

18. The system of claim 17, wherein the candidate group verification apparatus compares the fingerprint of the search result candidate group with the fingerprint of the query publication, identifies the query publication on the basis of the comparison result, and
obtains additional information about the query publication from the DBMS and provides the obtained additional information when the query publication is determined to be in the DBMS.

19. A method of identifying a publication using a fingerprint, comprising:
extracting a fingerprint of a collected query publication;
searching a database management system (DBMS) for a fingerprint of an original publication corresponding to the fingerprint extracted from the collected query publication; and
identifying the collected query publication on the basis of at least one search result.

20. The method of claim 19, wherein identifying the collected query publication on the basis of the at least one search result includes identifying the query publication on the basis of a comparison result obtained by comparing the at least one search result with the fingerprint of the query publication, and obtaining additional information about the query publication from the DBMS when it is determined as a result of identifying the collected query publication that the query publication is identical to the original publication.
